(19) United States
(12) Patent Application Publication
(10) Pub. No.: US 2010/0058596 A1
(43) Pub. Date: Mar. 11, 2010

(54) DRIVING STRUCTURE OF LOW NOISE CLIPPER USING COMPRESSED AIR

(76) Inventor: Gook Hyun Shim, Daejeon (KR)

Correspondence Address: PARK LAW FIRM, 3255 WILSHIRE BLVD, SUITE 1110, LOS ANGELES, CA, 90010, US

(21) Appl. No.: 12/517,347

(22) PCT Filed: Dec. 6, 2007
(86) PCT No.: PCT/KR2007/006292

§ 371 Date: Jun. 2, 2009

(30) Foreign Application Priority Data
Dec. 6, 2006 (KR) 10-2006-0122731

(51) Int. Cl. B26B 19/34

(52) U.S. Cl. 30/216

(57) ABSTRACT

The present invention is related to a driving structure of a low noise pneumatic clipper, and an object of the present invention is to use a compressed air in order for driving a cutting comb. The present invention includes a main body, a cutting comb installed on the front side of the main body, and a driving means installed in the inside of the main body to operate the cutting comb. In the present invention, in the inside of the main body, a driving compartment is formed on the center part of the main body to separate the cutting comb from the driving means and a ventilation chamber is formed to surround the driving compartment and to form an inner wall of the main body. the driving compartment and the ventilation chamber are connected by a passing through hole which is position on the upper side of the passing through hole and is connected to an exhaust pipe.

### TECHNICAL FIELD

The present invention is related to a driving structure of a clipper, and, more particularly, a driving structure of a low noise clipper which uses a compressed air in order to drive a cutting comb of the clipper for cutting a hair or a mustache with low noise when used.

### BACKGROUND ART

Generally, a clipper is a device which cuts a mustache or a beard by reciprocally actuating a cutting comb. The cutting comb is driven by a driving means such as a motor or a linear actuator which is installed within a main body of the clipper.

Generally, the driving means installed in the clipper is actuated by applied power. As the motor or linear actuator used as the driving means is used repeatedly and continuously, the inside of the main body of the clipper is heated to increase the temperature of the main body.

There is a problem that when the clipper is used repeatedly, the heated motor or linear actuator increases the temperature in the main body and the increased temperature shorts an electrical connection part of the clipper.

In addition, the heated motor or linear actuator makes a noise as used for long time. Therefore, the clipper makes a noise in a beauty shop or a barbershop, when the clipper is used in the beauty shop or barbershop.

### DISCLOSURE OF INVENTION

### Technical Solution

Therefore, the present invention is invented to solve the above-mentioned problem. An object of the present invention is to provide a driving structure of a low noise clipper which is not operated by an electrical power generating heat but a compressed air to realize low noise.

In one preferred embodiment of the present invention, a driving structure of a pneumatic clipper is provided with a multistage rotor and a nozzle in the main body of the clipper in order for solving the above mentioned problem. The nozzle is for ejecting a highly compressed air to the rotating direction of the rotor

The rotor and nozzle used in the present invention are installed in a driving compartment. A ventilation chamber surrounding the driving compartment is formed in the inside of the main body.

Other objects and effects of the present invention will be clearly understood from the following description, and the detailed description and examples for explaining preferred embodiments should be not understood to limit the scope of the present invention.

### Advantageous Effects

By the driving structure of the low noise pneumatic clipper according to the present invention, an electrical energy generating heat is not needed and low noise can be achieved. Further, the driving structure of the low noise clipper operated by a compressed air is provide to reduce the noise in a beauty shop. As the clipper is constituted by a simple rotor structure, a possibility of break down can be remarkably reduce, and reliability of the clipper can be remarkably increased.

### BRIEF DESCRIPTION OF THE DRAWINGS

The above objects and other advantages of the present invention will become more apparent by describing in detail the preferred embodiments of the present invention with reference to the attached drawings in which:

FIG. 1 is a diagram which shows an in-use state of a clipper according to the present invention;

FIG. 2 is a perspective diagram which shows an inner structure of a clipper according to the present invention;

FIG. 3 is a cross-section diagram of the inner side of a main body in which a driving means is installed according to the present invention; and

FIG. 4 is a diagram showing a structure of a rotor according to the present invention.

### BRIEF DESCRIPTION OF REFERENCE NUMBERS

10: main body 12: cutting comb
20: driving compartment 16: ventilation chamber
20: driving means 22: rotor
24: rotating axis 28: supplying pipe
30: compressor 40: passing through hole
50: exhausting pipe

### BEST MODE FOR CARRYING OUT THE INVENTION

According to the present invention, a cutting comb is installed on a front side of a main body of a clipper, and a driving means for actuating the cutting comb is installed in the main body.

A driving structure of the clipper is characterized by that, in the inside of the main body, a driving compartment is formed on the center part of the main body to separate the cutting comb from the driving means, a ventilation chamber is formed to surround the driving compartment and to form an inner wall of the main body, and the driving compartment and the ventilation chamber are connected by a passing through hole which is position on the upper side of the passing through hole and is connected to an exhaust pipe.

Further, the driving means is characterized by at least one rotor, a rotating axis passing through the center of the rotor, a nozzle which is installed to be positioned on the lower part of the rotor and to be inclined, a supplying pipe which is connected with the nozzle to extend to the outside of the main body, and a compressor which supplies a compressed air to the extended pipe.

Preferably, the present invention is characterized that, in the axial direction, the radius of one rotor which is installed to a direction to which the cutting comb is positioned is smaller than that of other rotor which is positioned on the front side.

Further, the present invention is characterized that the rotor is formed by a snake-shaped blade.

Further, the present invention is characterized that the rotating axis is fixed by a bearing on the upper and lower sides.

Hereinafter, a preferred embodiment of the present invention will be described in detail with reference to the accompanying drawings. Throughout the drawings, same reference numbers are used for functionally same parts or similar parts.

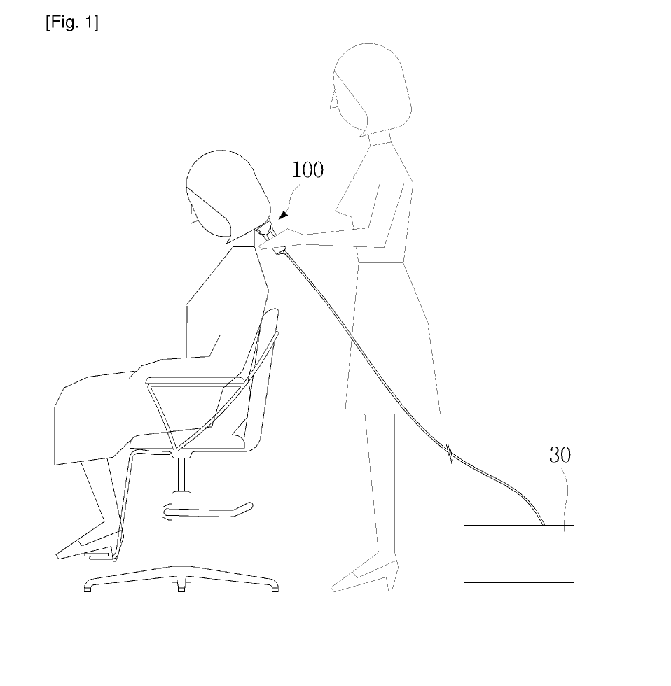

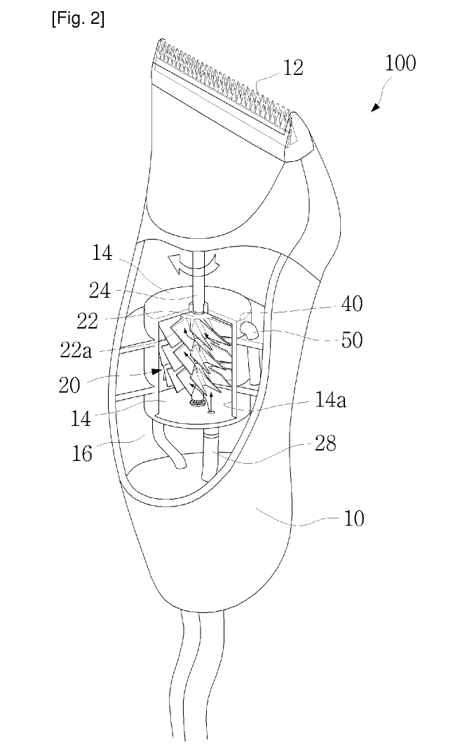

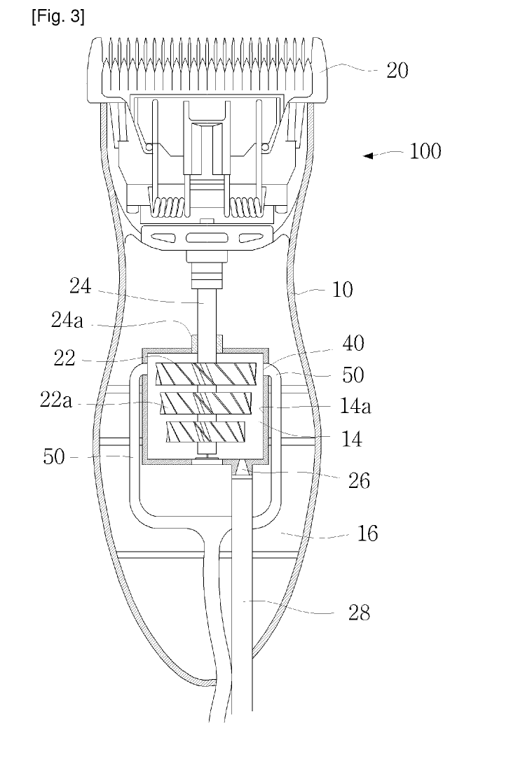

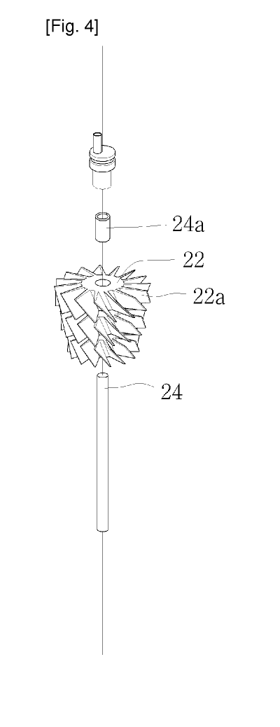

FIG. 1 is a diagram which shows an in-use state of a clipper according to the present invention. FIG. 2 is a perspective diagram which shows an inner structure of a clipper according to the present invention, FIG. 3 is a cross-section diagram of the inner side of a main body in which a driving means is installed according to the present invention, and FIG. 4 is a diagram showing a structure of a rotor according to the present invention.

Referring to FIGS. 1 to 4, a driving structure of a pneumatic clipper is formed by a main body 10, a cutting comb 12 which is positioned on the front side of the main body 10, and a driving means 20 which is installed in the main body 10 to drive the cutting comb 12. The clipper can be applied to a conventional clipper 100.

The driving means 20 and the cutting comb 12 which is driven by the driving means 20 to cut hair, a mustache or a beard are installed in the main body 10.

In the inside of the main body 10, a driving compartment 14 is installed along an axis direction of the main body 10 to separate the cutting comb 12 and the driving means 20 from each other. Here, the axis direction means the length direction of the clipper 100.

The driving compartment 14 is surrounded by a ventilation chamber 16 which defines a specific space. The ventilation chamber 16 forms the inner wall of the main body 10. The ventilation chamber performs a soundproof part when the driving means 20 is actuated.

Again, in the present invention, the driving means 20 installed in the inside of the driving compartment 14 is constituted by at least one rotor 22, a rotating axis 24 passing through the center of the rotor 22, a nozzle 26 which is installed to be positioned on the lower part of the rotor 22 and to be inclined, a supplying pipe 28 which is connected with the nozzle 26 to extend to the outside of the main body 10, and a compressor 30 which supplies a compressed air to the extended pipe 28.

Numbers of rotors according to the present invention are installed along the axial direction in sequential. Preferably, three rotors are installed according to one embodiment.

More preferably, the radius of one rotor 22 which is installed to a direction to which the cutting comb 22 is positioned is smaller than that of other rotor 22 which is position on the front side.

Most preferably, a blade 22a of the rotor 22 according to the present invention is formed as a snake-shaped to have a constant inclination. As described just before, a compressed air supplied to the axial direction strikes the blade 22a to rotate the rotor 22 without a particular loss due to the snake-shaped blade 22a. That is to say, as exhausting pressure of the compressed air flows along the inner side of the snake-shaped blade 22a, the exhausting pressure can be sufficiently transferred to the rotating axis 24.

In the present invention, the rotor 22 is supported by the rotating axis 24, and the rotating axis 24 is rotatably supported on a side wall 14a of the driving compartment 14 through a bearing 24a.

The rotating axis 24 is connected to the cutting comb 12. The rotating axis performs the same operation as that of the motor described in the Korean patent laid-open No. 2005-0021900, “Vibration preventing structure for hair cutter”, and the Korean registered patent No. 0316127, “Automatic reciprocal razor with circular razor blade”.

As described above, the present invention includes the nozzle 26 which is positioned and installed on the lower part of the rotor 22 connected to the rotating axis 24. It is preferred that the nozzle 26 is installed to make 100°˜160° from the inner side of the snake-shaped blade 22a. As the nozzle 26 is installed to have such position, a compressed air strikes the inner side of the blade 22a and the blade 22a is rotated by the strike. As described above, in the present invention, the compressed air striking the snake-shaped blade 22a flows upward along the inner side, and the flowing compressed air is transferred to the upper side of the blade 22a of the rotor 22. Therefore, the rotating power of blade 22 can be increased.

The nozzle 26 is connected to the supplying pipe 28 which transfers the compressed air. The supplying pipe 28 passes through the ventilation chamber 16 to extend to the outside of the main body 10.

In the present invention, the compressed air is supplied from the conventional compressor 30 installed on the outside. The compressor 30 is generally installed on the outside of a beauty shop to generate a minimized noise. The compressor makes only a compressed air to supply to the clipper 100 according to the present invention.

According to the present invention, the compressed air supplied from the compressor 30 should be quickly exhausted to the outside after rotating the rotor 22 in order to rotate the rotor smoothly.

In order for rotating the rotor smoothly, a passing through hole 40 is formed on the driving compartment 14 to communicate the driving compartment 14 provided with the rotor 22 with the ventilation chamber 16. Preferably, the passing through hole 14 is formed on the upper side of the side wall 14a of the driving compartment 14 on which the rotor 22 is positioned.

The exhausting pipe 50 is connected to the passing through hole 40, passed through the ventilation chamber 16 to extent to the outside. With such constitution, the exhausting pipe rotates the rotor 22, and then, exhausts the compressed air to the outside.

Preferably, an end of the exhausting pipe 50 extended to the outside can be installed with a suction pump to exhaust the compressed air quickly.

With the above described constitution, as the present invent uses a compressed air, a noise caused by a motor can be reduced in case of using the clipper 100 according to the present invention. Therefore, a noise in a beauty shop can be reduced.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. In a driving structure of a clipper using a compressed air, the clipper having a main body, a cutting comb positioned on the front side of the main body, and a driving means installed in the main body to drive the cutting comb, the driving means including at least one rotor, a rotating axis passing through the center of the rotor, a nozzle installed to be positioned on the lower part of the rotor and to be inclined, a supplying pipe connected with the nozzle to extend to the outside of the main body, and a compressor for supplying a compressed air to the extended pipe, in the inside of the main body, a driving compartment being formed on the center part of the main body to separate the cutting comb from the driving means and a ventilation chamber being formed to surround the driving compartment and to form an inner wall of the main body, and the driving compartment and the ventilation chamber being connected by a passing through hole positioned on the upper side of the passing through hole and connected to an exhaust pipe, said driving structure of the clipper using the compressed air is characterized by that the radius of one rotor which is installed to a direction to which the cutting comb is positioned is smaller than that of other rotor which is position on the front side.

2. A driving structure of a clipper using a compressed air as claimed in claim 1, wherein the rotating axis is fixed by a bearing on the upper and lower side wall of the driving compartment.
